(19) United States
(12) Patent Application Publication
(10) Pub. No.: US 2024/0330235 A1
(43) Pub. Date: Oct. 3, 2024

(54) REQUEST ALLOCATION METHOD FOR VIRTUAL CHANNEL, AND RELATED APPARATUS

(71) Applicant: SUZHOU METABRAIN INTELLIGENT TECHNOLOGY CO., LTD., Suzhou (CN)

(72) Inventors: Huilin ZHANG, Suzhou (CN); Tao YUAN, Suzhou (CN); Ruizhen WU, Suzhou (CN)

(21) Appl. No.: 18/740,289

(22) Filed: Jun. 11, 2024

Related U.S. Application Data
(63) Continuation of application No. PCT/CN2023/085072, filed on Mar. 30, 2023.

(30) Foreign Application Priority Data
May 31, 2022 (CN) 202210609375.2

(51) Int. Cl. G06F 15/78; H04L 9/40; H04L 45/586

(52) U.S. Cl. CPC G06F 15/7825; H04L 45/586; H04L 63/10

(57) ABSTRACT

A request allocation method and apparatus for a virtual channel, a terminal device and a non-transitory readable storage medium are provided. The method includes: inputting a request that is received into a valid input buffer; in response to that there is a valid request in the valid input buffer, regulating a working voltage and/or a working frequency of a dynamic virtual channel access group according to a current working state of the dynamic virtual channel access group; inputting the request into the dynamic virtual channel access group of a corresponding priority according to a priority of the request; and outputting the request to a corresponding physical channel through the dynamic virtual channel access group to improve the efficiency of the request allocation, reduce the energy waste and increase the utilization rate.

### CROSS-REFERENCE TO RELATED APPLICATION

This application claims the priority of the Chinese Patent application filed on May 31, 2022 before the China National Intellectual Property Administration with the application number of 202210609375.2, and the title of “REQUEST ALLOCATION METHOD FOR VIRTUAL CHANNEL, AND RELATED APPARATUS”, which is incorporated herein in its entirety by reference.

### FIELD

The present application relates to the technical field of network-on-chip (NOC) and, more particularly, to a request allocation method for a virtual channel, a request allocation apparatus for the virtual channel, a terminal device, and a non-transitory readable storage medium.

### BACKGROUND

With the increasing scale and complexity of a system-on-chip (SOC), the interconnection method that separates computation from communication, represented by the NOC, has attracted significant attention. It is widely utilized in complex SOC designs, including but not limited to application processor chips (such as interconnections between video codec intellectual property (IP) cores, graphics processing units (GPUs), and artificial intelligence (AI) processors and interconnections between the above-mentioned processors and external memories), as well as memory chips (interconnections of processing engines in compression/decompression IPs and interconnections between compression/decompression IPs and external memories).

In the related art, a traditional Router that supports a virtual channel typically divides the processing of input and output into two steps. In the first step, an input request first requests to acquire an output virtual channel in a corresponding input virtual channel. In the second step, the output virtual channel requests to acquire an output physical channel for data packet transmission according to an exchange allocation logic. The exchange allocation logic also requires two steps to complete the exchange allocation. In the first step, the input virtual channel is tried to apply for the output physical channel. In the second step, a selection is made in the successfully applied set to guide the selection of the output virtual channel to the physical channel. However, the virtual channel is inefficient in processing requests and has a high power consumption at the same time.

### SUMMARY

An object of the present application is to provide a request allocation method for a virtual channel, a request allocation apparatus for the virtual channel, a terminal device, and a non-transitory readable storage medium to improve the efficiency of request allocation.

In order to solve the technical problem stated above, a request allocation method for a virtual channel is provided by the present application, which includes:
inputting a request that is received into a valid input buffer;
in response to that there is a valid request in the valid input buffer, regulating a working voltage and/or a working frequency of a dynamic virtual channel access group according to a current working state of the dynamic virtual channel access group;
inputting the request into the dynamic virtual channel access group of a corresponding priority according to a priority of the request; and
outputting the request to a corresponding physical channel through the dynamic virtual channel access group.

In some embodiments, inputting the request that is received into the valid input buffer includes:
receiving the request, and inputting the request into an access policy firewall;
in response to that the request conforms to a policy of the access policy firewall, sending the request to the valid input buffer; and
in response to that the request does not conform to the policy of the access policy firewall, sending access error information to a requester.

In some embodiments, inputting the request that is received into the valid input buffer includes:
in response to that the request is received, reducing a current credit value by one to obtain a new current credit value, and inputting the request into the valid input buffer; and
in response to that the current credit value is zero, sending a message corresponding to suspending receiving the current credit value.

In some embodiments, in response to that there is the valid request in the valid input buffer, regulating the working voltage and/or the working frequency of the dynamic virtual channel access group according to the current working state of the dynamic virtual channel access group includes:
in response to that there is the valid request in the valid input buffer, determining whether the current working state of the dynamic virtual channel access group is an idle state; and
in response to that the current working state is the idle state, restoring the working voltage and/or the working frequency of the dynamic virtual channel access group to a normal state.

In some embodiments, restoring the working voltage and/or the working frequency of the dynamic virtual channel access group to the normal state includes:
in response to that the dynamic virtual channel access group is set to an active state, restoring the voltage of the dynamic virtual channel access group to a normal working voltage; and
in response to that the voltage is restored to the normal working voltage, restoring the working frequency of the dynamic virtual channel access group to a normal working frequency.

In some embodiments, in response to that there is the valid request in the valid input buffer, regulating the working voltage and/or the working frequency of the dynamic virtual channel access group according to the current working state of the dynamic virtual channel access group includes:
in response to that there is the valid request in the valid input buffer, determining whether the current working state of the dynamic virtual channel access group is a semi-idle state; and
in response to that the current working state is the semi-idle state, restoring the working frequency of the dynamic virtual channel access group to the normal state.

In some embodiments, restoring the working frequency of the dynamic virtual channel access group to the normal state includes:
in response to that the dynamic virtual channel access group is set to an active state, restoring the working frequency of the dynamic virtual channel access group to the normal state.

In some embodiments, inputting the request into the dynamic virtual channel access group of the corresponding priority according to the priority of the request includes:
in response to that the priority of the request is a high priority, inputting the request into the dynamic virtual channel access group of the high priority; and
in response to that the priority of the request is a low priority, inputting the request into the dynamic virtual channel access group of the low priority.

In some embodiments, outputting the request to the corresponding physical channel through the dynamic virtual channel access group includes:
outputting the request from the dynamic virtual channel access group to the corresponding physical channel through dynamic priority arbitration.

In some embodiments, the request allocation method further includes:
in response to that the dynamic virtual channel access group is in an inactive state, controlling the dynamic virtual channel access group to work at a first working voltage and a first working frequency, wherein the first working voltage is less than a normal working voltage, and the first working frequency is less than a normal working frequency.

In some embodiments, in response to that the dynamic virtual channel access group is in the inactive state, controlling the dynamic virtual channel access group to work at the first working voltage and the first working frequency includes:
in response to that the dynamic virtual channel access group is in the inactive state, controlling the dynamic virtual channel access group to work at the first working frequency; and
in response to that a duration of working at the first working frequency is longer than a preset duration, controlling the dynamic virtual channel access group to work at the first working voltage.

In some embodiments, outputting the request to the corresponding physical channel through the dynamic virtual channel access group includes:
outputting the request from the dynamic virtual channel access group to the corresponding physical channel through dynamic priority arbitration of 8 transmission channels.

In some embodiments, receiving the request, and inputting the request into the access policy firewall includes:
receiving the request, and inputting an access type, an access attribute, and an access address of the request into the access policy firewall.

In some embodiments, the access policy firewall includes: a source/destination and access type/access attribute determination circuit and an access address determination circuit; the source/destination and access type/access attribute determination circuit is configured to determine whether an access type and an access attribute of the request support a trust zone access, and the access address determination circuit is configured to detect whether a corresponding access address is within a configured accessible address range according to a source identifier (ID) of the request.

In some embodiments, the request allocation method further includes:
in response to that the access type and the access attribute of the request support the trust zone access, and according to the source ID of the request, it is detected that the corresponding access address is within the configured accessible address range, determining that the request conforms to the policy of the access policy firewall.

In some embodiments, the request allocation method further includes:
in response to that any one or more of the following are satisfied, determining that the request conforms to the policy of the access policy firewall:
the access type and/or the access attribute of the request not supporting the trust zone access, and according to the source ID of the request, detecting that the corresponding access address is not within the configured accessible address range.

In some embodiments, inputting the request into the dynamic virtual channel access group of the corresponding priority according to the priority of the request includes:
inputting the request into the dynamic virtual channel access group of the corresponding priority according to the priority, a destination identifier (ID), and an access type of the request.

A request allocation apparatus for a virtual channel is further provided by the present application, which includes:
a request caching module, configured to input a request that is received into a valid input buffer;
a voltage frequency regulation module, configured to in response to that there is a valid request in the valid input buffer, regulate a working voltage and/or a working frequency of a dynamic virtual channel access group according to a current working state of the dynamic virtual channel access group;
a virtual channel caching module, configured to input the request into the dynamic virtual channel access group of a corresponding priority according to a priority of the request; and
a request output module, configured to output the request to a corresponding physical channel through the dynamic virtual channel access group.

A terminal device is further provided by the present application, which includes:
a memory, configured to store a computer program; and
a processor, configured to implement the steps of the request allocation method stated above in response to executing the computer program.

A non-transitory readable storage medium storing a computer program is further provided by the present application, wherein in response to that the computer program is executed by a processor, the steps of the request allocation method stated above are implemented.

The request allocation method for a virtual channel provided by the present application includes: inputting the request that is received into the valid input buffer; in response to that there is a valid request in the valid input buffer, regulating the working voltage and/or the working frequency of the dynamic virtual channel access group according to the current working state of the dynamic virtual channel access group; inputting the request into the dynamic virtual channel access group of the corresponding priority according to the priority of the request; and outputting the request to the corresponding physical channel through the dynamic virtual channel access group. In response to that there is the valid request in the valid input buffer, the working voltage and/or the working frequency of the dynamic virtual channel access group are regulated according to the current working state of the dynamic virtual channel access group, it is realized that the voltage and the frequency of the dynamic virtual channel access group are dynamically regulated, rather than using a fixed voltage and frequency to work, thereby the efficiency of processing the request is improved. Meanwhile, the request is inputted into the dynamic virtual channel access group of the corresponding priority according to the priority of the request to achieve differential processing on requests of different priorities, thereby the efficiency of the request allocation is further improved.

The request allocation apparatus for the virtual channel, the terminal device, and the non-transitory readable storage medium further provided by the present application also have the above-mentioned beneficial effects, which will not described in detail herein.

### BRIEF DESCRIPTION OF THE DRAWINGS

In order to explain the embodiments of the present application or the technical solutions in the related art more clearly, a brief description will be given below with reference to the accompanying drawings which are needed to be used in the description of the embodiments or the related art, and it is obvious that the drawings in the description below are merely some embodiments of the present application, and a person skilled in the art may obtain other drawings according to these provided drawings without involving any creative effort.

FIG. 1 is a flowchart of a request allocation method for a virtual channel according to an embodiment of the present application;

FIG. 2 is a schematic structural diagram of a request allocation apparatus for a virtual channel according to an embodiment of the present application;

FIG. 3 is a determination schematic diagram of an access policy firewall of a request allocation apparatus for a virtual channel according to an embodiment of the present application;

FIG. 4 is a schematic diagram of a virtual channel access group of a request allocation apparatus for a virtual channel according to an embodiment of the present application;

FIG. 5 is a work flowchart of a virtual channel access group of a request allocation apparatus for a virtual channel according to an embodiment of the present application; and

FIG. 6 is a schematic diagram of a non-transitory readable storage medium according to an embodiment of the present application.

### DETAILED DESCRIPTION

The core of the present application is to provide a request allocation method for a virtual channel, a request allocation apparatus for the virtual channel, a terminal device, and a non-transitory readable storage medium to improve the efficiency of request allocation.

In order to make the object, technical solutions, and advantages of the embodiments of the present application clearer, the technical solutions in the embodiments of the present application will be clearly and completely described below in conjunction with the accompanying drawings in the embodiments of the present application. Obviously, the embodiments described are some embodiments of the present application, not all embodiments. According to the embodiments in the present application, all other embodiments obtained by a person skilled in the art without involving any creative effort fall within the scope of the present application.

In the related art, a traditional Router that supports a virtual channel typically divides the processing of input and output into two steps. In the first step, an input request first requests to acquire an output virtual channel in a corresponding input virtual channel. In the second step, the output virtual channel requests to acquire an output physical channel for data packet transmission according to an exchange allocation logic. The exchange allocation logic also requires two steps to complete the exchange allocation. In the first step, the input virtual channel is tried to apply for the output physical channel. In the second step, a selection is made in the successfully applied set to guide the selection of the output virtual channel to the physical channel. However, the virtual channel is inefficient in processing requests and has a high power consumption at the same time.

In response to that there is a valid request in a valid input buffer, a working voltage and/or a working frequency of a dynamic virtual channel access group are regulated according to a current working state of the dynamic virtual channel access group, it is realized that the voltage and the frequency of the dynamic virtual channel access group are dynamically regulated, rather than using a fixed voltage and frequency to work, thereby the efficiency of processing the request is improved. Meanwhile, the request is inputted into the dynamic virtual channel access group of a corresponding priority according to a priority of the request to achieve differential processing on requests of different priorities, thereby the efficiency of request allocation is further improved.

A request allocation method for a virtual channel provided by the present application is described below through one embodiment.

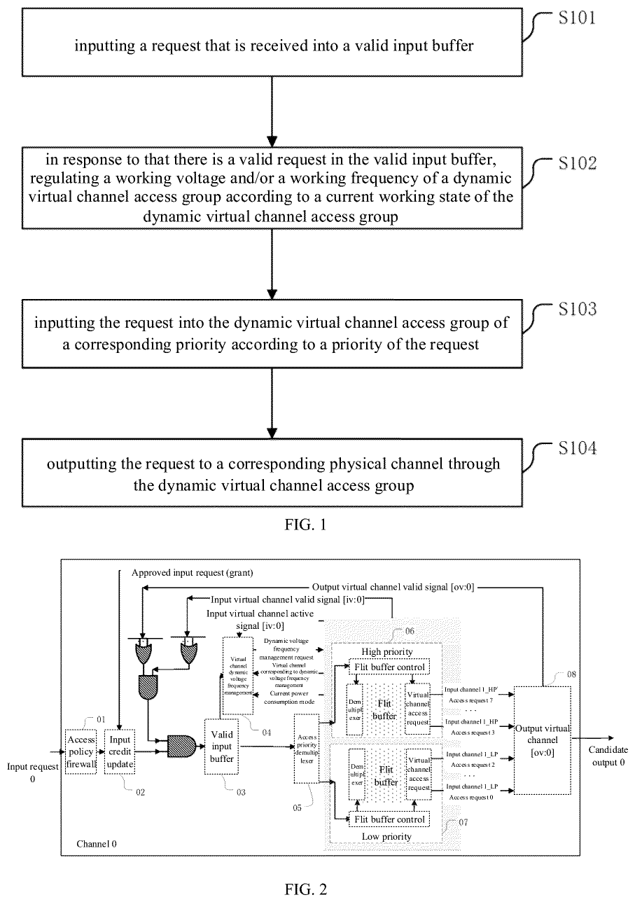

Referring to FIG. 1, FIG. 1 is a flowchart of a request allocation method for a virtual channel according to an embodiment of the present application.

In the present embodiment, the method may include S101 to S104.

S101, inputting a request that is received into a valid input buffer.

This step is intended to input the request that is received into the valid input buffer. That is, the request that is received is first placed into the valid input buffer so that the request is processed in the valid input buffer. Further, an access policy may be determined for the request to process the request. That is, an access policy determination is performed on the request to determine whether the request conforms to access requirements. The valid input buffer is a buffer that pre-processes a request.

Further, this step may include:
step 1, receiving the request, and inputting the request into an access policy firewall;
step 2, in response to that the request conforms to a policy of the access policy firewall, sending the request to the valid input buffer; and
step 3, in response to that the request does not conform to the policy of the access policy firewall, sending access error information to a requester.

It may be seen that in some embodiments of the present application, it is primarily described how to process the request in the valid input buffer. In some embodiments of the present application, the request is received and inputted into the access policy firewall. In response to that the request conforms to the policy of the access policy firewall, the request is sent to the valid input buffer. In response to that the request does not conform to the policy of the access policy firewall, the access error information is sent to the requester. The policy of the access policy firewall may determine whether the request conforms to the requirements, so that the requests that do not conform to the requirements are filtered and the efficiency of processing is improved.

The request may be received, and an access type, an access attribute, and an access address of the request are inputted into the access policy firewall, so that the access policy firewall determines based on the access type, the access attribute, and the access address.

In some embodiments of the present application, the access policy firewall includes: a source/destination and access type/access attribute determination circuit and an access address determination circuit. The source/destination and access type/access attribute determination circuit is configured to determine whether an access type and an access attribute of the request support a trust zone access, and the access address determination circuit is configured to detect whether a corresponding access address is within a configured accessible address range according to a source identifier (ID) of the request.

In some embodiments of the present application, in response to that the access type and the access attribute of the request support the trust zone access, and according to the source ID of the request, it is detected that the corresponding access address is within the configured accessible address range, it is determined that the request conforms to the policy of the access policy firewall. In response to that the access type and/or the access attribute of the request do not support the trust zone access, it is determined that the request does not conform to the policy of the access policy firewall; or in response to that according to the source ID of the request, it is detected detects that the corresponding access address is not within the configured accessible address range, it is determined that the request does not conform to the policy of the access policy firewall.

Further, this step may include:
step 1, in response to that the request is received, reducing a current credit value by one to obtain a new current credit value, and inputting the request into the valid input buffer; and
step 2, in response to that the current credit value is zero, sending a message corresponding to suspending receiving the current credit value.

It may be seen that in some embodiments of the present application, it is primarily described how to process the request in the valid input buffer. In some embodiments of the present application, in response to that the request is received, the current credit value is reduced by one to obtain the new current credit value, and the request is inputted into the valid input buffer. In response to that the current credit value is zero, the message corresponding to suspending receiving the current credit value is sent. Further, in the present embodiment, in order to prevent excessive processing of a certain type of request from affecting other request processing processes, a corresponding credit value is set for this type of request and reduced by one after each processing. In response to that the credit value is 0, processing is stopped, i.e., receiving the message is suspended to avoid a situation where request messages are congested, thereby the efficiency of processing the messages is improved.

S102, in response to that there is a valid request in the valid input buffer, regulating a working voltage and/or a working frequency of a dynamic virtual channel access group according to a current working state of the dynamic virtual channel access group.

On the basis of S101, this step is intended to regulate the working voltage and/or working frequency of the dynamic virtual channel access group according to the current working state of the dynamic virtual channel access group in response to that there is the valid request in the valid input buffer. That is, the present embodiment dynamically adjusts the working voltage and/or the working frequency according to the current working state through this step, and the working voltage and the working frequency of the dynamic virtual channel access group are not constantly maintained in a certain state, the utilization rate of the performance is improved and the problem of performance waste is avoided. The valid request is the request that conforms to the policy of the access policy firewall.

The dynamic virtual channel access group is a virtual channel for transmitting a request in the NOC, and the request is transmitted to a corresponding port by being allocated to a corresponding output channel in the virtual channel. Generally, the working frequency and the working voltage of the dynamic virtual channel access group are in a constant state, but for the dynamic virtual channel access group, not every moment there is a request that needs to be processed. Therefore, in response to that the number of requests is small or there is no request, the dynamic virtual channel access group still consumes the same energy consumption, resulting in a waste of resources.

Therefore, the dynamic virtual channel access group in this step may adjust the working frequency and the working voltage according to the working state. The working states may include an active state, a semi-idle state, and an idle state. Each working state corresponds to a different working voltage and working frequency. In response to that the dynamic virtual channel access group is in the active state, both the working voltage and the working frequency are in a standard working state. In response to that the dynamic virtual channel access group is in the semi-idle state, the working voltage is in the standard working state, and the working frequency is at a low working frequency. In response to that the dynamic virtual channel access group is in the idle state, both the working voltage and the working frequency are in a low working state.

Further, this step may include:
step 1, in response to that there is the valid request in the valid input buffer, determining whether the current working state of the dynamic virtual channel access group is an idle state; and
step 2, in response to that the current working state is the idle state, restoring the working voltage and/or the working frequency of the dynamic virtual channel access group to a normal state.

It may be seen that in some embodiments of the present application, it is primarily described how to perform dynamic adjustment. In some embodiments of the present application, in response to that there is the valid request in the valid input buffer, it is determined whether the current working state of the dynamic virtual channel access group is the idle state. In response to that the current working state is the idle state, the working voltage and/or the working frequency of the dynamic virtual channel access group are restored to a normal state. That is, in response to that there is the valid request to be processed, if the dynamic virtual channel access group is in the idle state, the idle state needs to be changed to the working state for processing. That is, the working voltage and the working frequency are restored to the working state.

In some embodiments of the present application, in response to that there is the valid request in the valid input buffer, regulating the working voltage and/or the working frequency of the dynamic virtual channel access group according to the current working state of the dynamic virtual channel access group includes: in response to that there is the valid request in the valid input buffer, determining whether the current working state of the dynamic virtual channel access group is the semi-idle state; and in response to that the current working state is the semi-idle state, restoring the working frequency of the dynamic virtual channel access group to the normal state.

In some embodiments of the present application, restoring the working frequency of the dynamic virtual channel access group to the normal state includes: in response to that the dynamic virtual channel access group is set to the active state, restoring the working frequency of the dynamic virtual channel access group to the normal state.

In practical application, in response to that the dynamic virtual channel access group is in the semi-idle state, the working frequency is restored to the normal state. The dynamic adjustment of the working voltage and the working frequency is realized, and the utilization rate of the performance is improved.

Further, step 2 of the above solution may include:
step 21, in response to that the dynamic virtual channel access group is set to an active state, restoring the voltage of the dynamic virtual channel access group to a normal working voltage; and
step 22, in response to that the voltage is restored to the normal working voltage, restoring the working frequency of the dynamic virtual channel access group to a normal working frequency.

It may be seen that in some embodiments of the present application, it is primarily described how to restore to the normal state. In some embodiments of the present application, in response to that the dynamic virtual channel access group is set to the active state, the voltage of the dynamic virtual channel access group is restored to the normal working voltage. In response to that the voltage is restored to the normal working voltage, the working frequency of the dynamic virtual channel access group is restored to the normal working frequency. That is, the working state is first set to the active state, then the working voltage is increased, and finally, the working frequency is increased. The dynamic adjustment is realized, and the utilization rate of the performance is improved.

Further, the present embodiment may further include:
in response to that the dynamic virtual channel access group is in an inactive state, the dynamic virtual channel access group is controlled to work at a first working voltage and a first working frequency, wherein the first working voltage is less than the normal working voltage, and the first working frequency is less than the normal working frequency.

It may be seen that in some embodiments of the present application, it is primarily described how to operate in the inactive state. In some embodiments of the present application, in response to that the dynamic virtual channel access group is in the inactive state, the dynamic virtual channel access group is controlled to work at the first working voltage and the first working frequency. The first working voltage is less than the normal working voltage, and the first working frequency is less than the normal working frequency. The inactive state is the idle state. Thus, in response to that the dynamic virtual channel access group is in the idle state, both the working voltage and the working frequency are set to the low working state. It may be seen that the dynamic adjustment is realized, and the utilization rate of the performance is improved.

Further, the above solution may include:
step 1, in response to that the dynamic virtual channel access group is in the inactive state, controlling the dynamic virtual channel access group to work at the first working frequency; and
step 2, in response to that a duration of working at the first working frequency is longer than a preset duration, controlling the dynamic virtual channel access group to work at the first working voltage.

It may be seen that in response to that the dynamic virtual channel access group is in the inactive state, the dynamic virtual channel access group is controlled to work at the first working frequency. In response to that the duration of working at the first working frequency is longer than the preset duration, the dynamic virtual channel access group is controlled to work at the first working voltage. It may be seen that in the embodiments of the present application, the dynamic adjustment is realized, and the utilization rate of the performance is improved.

S103, inputting the request into the dynamic virtual channel access group of a corresponding priority according to a priority of the request.

On the basis of S102, the present step is intended to input the request into the dynamic virtual channel access group of the corresponding priority according to the priority of the request. That is, after the dynamic adjustment, the dynamic virtual channel access group processes the request, the utilization rate of performance is improved.

The request may be inputted into the dynamic virtual channel access group of the corresponding priority according to the priority, a destination ID, and an access type of the request, i.e., placing the request in a virtual channel of the same destination ID and access type.

Further, this step may include:
in response to that the priority of the request is a high priority, inputting the request into the dynamic virtual channel access group of the high priority; and in response to that the priority of the request is a low priority, inputting the request into the dynamic virtual channel access group of the low priority.

It may be seen that in some embodiments of the present application, it is primarily described how to perform request input according to the priority. In some embodiments of the present application, in response to that the priority of the request is the high priority, the request is inputted into the dynamic virtual channel access group of the high priority. In response to that the priority of the request is the low priority, the request is inputted into the dynamic virtual channel access group of the low priority.

S104, outputting the request to a corresponding physical channel through the dynamic virtual channel access group.

On the basis of S103, this step is intended to output the request to the corresponding physical channel through the dynamic virtual channel access group. That is, the output is realized by outputting a processed request to the corresponding physical channel.

Further, this step may include:
outputting the request from the dynamic virtual channel access group to the corresponding physical channel through dynamic priority arbitration.

It may be seen that in some embodiments of the present application, it is primarily described how to output the request according to the priority. In some embodiments of the present application, the request is outputted from the dynamic virtual channel access group to the corresponding physical channel through the dynamic priority arbitration, so that it is realized that the requests according to the precedence of priorities are output, rather than the requests are output at a uniform level, thereby the efficiency of outputting the requests is improved and the problem of the request of the high priority being delayed is avoided.

In summary, in the present embodiment, in response to that there is the valid request in the valid input buffer, the working voltage and/or the working frequency of the dynamic virtual channel access group are regulated according to the current working state of the dynamic virtual channel access group, so that it is realized that the voltage and the frequency of the dynamic virtual channel access group are dynamically regulated, rather than using a fixed voltage and frequency to work, thereby the efficiency of processing the request is improved. Meanwhile, the request is inputted into the dynamic virtual channel access group of the corresponding priority according to the priority of the request to achieve differential processing on requests of different priorities, thereby the efficiency of request allocation is further improved.

The request allocation apparatus for the virtual channel and the request allocation method for the virtual channel provided by the present application are further described below through another embodiment.

Referring to FIG. 2, FIG. 2 is a schematic structural diagram of a request allocation apparatus for a virtual channel according to an embodiment of the present application.

In the present embodiment, a structure of a NOC router that supports fast allocation of dynamic virtual channels is shown in FIG. 2. Compared with a traditional NOC router, in this NOC router, the router channel is mainly improved, an access policy firewall is added, dynamic virtual channels of priorities are distinguished, and dynamic virtual channel dynamic voltage frequency management is performed. While improving the security, the energy consumption of processing requests is saved, and the resource utilization rate is improved.

The process that the NOC router of the present embodiment processes the request is as follows.

Step 1, an input request enters an access policy firewall 01; in response to that the input request conforms to a firewall policy, the input request enters an input credit update processing logic for subsequent processing; and in response to that the input request does not conform to the firewall policy, the firewall returns an access error to a requester.

Step 2, in an input credit update logic 02, it is mainly determined whether a current input port may still accept subsequent inputs according to a current credit value. For example, credit values of the current input port being consumed completely represents that no virtual channel is available in the whole path, and back pressure needs to be performed on a pre-stage requester. No new access request is accepted temporarily, and an initial value of the credit value is statically and individually configured for each channel after the system is powered on. The process of updating the credit value may be simply understood as reducing the credit value by 1 after accepting one valid request, and increasing the credit value by 1 after completing the whole transmission.

Step 3, in a valid input buffer 03, an input request conforming to an access policy is combined with input and output virtual channel valid signals to generate a final valid request to enter the valid input buffer 03.

Step 4, in dynamic virtual channel voltage frequency management 04, all the virtual channels in an inactive state are powered by using a working voltage lower than a normal voltage and use a clock frequency lower than a normal working frequency. In response to that there is a valid request in the valid input buffer, a working state of a corresponding virtual channel is checked. If the virtual channel is in the inactive state, the normal voltage and working frequency are restored, and a data packet of the valid request enters the corresponding virtual channel. In response to that an idle counter of the virtual channel reaches a threshold one (indicating that there is no transmission during the period), a dynamic frequency control is requested, and the clock frequency lower than the normal working frequency is used. If the idle counter of the virtual channel reaches a threshold two (the threshold two is greater than the threshold one), the working voltage lower than the normal voltage is requested to power. In response to that there is a request to be transmitted later, the normal voltage and working frequency are requested to be restored. If a request occurs when the idle counter reaches the threshold one but does not reach the threshold two, it is only necessary to restore the normal clock frequency. The threshold one and the threshold two may be set according to actual situations and are not defined herein.

Step 5, in an access priority demultiplexer 05, the input request is decomposed into a corresponding high-priority dynamic virtual channel access group 06 or low-priority dynamic virtual channel access group 07 according to priorities in the flit in the request (referring to Table 1).

Step 6, an output virtual channel 08 and 8:1 dynamic priority arbitration complete the mapping from the final output virtual channel to a physical channel, and the output is completed.

TABLE 1
Priorities and group definitions

| Service | | | |
|---|---|---|---|
| level | | Corresponding | Corresponding access |
| number | Priority | group | type definition |
| 0 | High | High-priority | Urgent (corresponding urgent = 1 |
| | | access group | in data header flit) |
| | | | Interruption |
| | | | Control signal with low latency |
| | | | requirement |
| | | | Short data packet (length less than |
| | | | or equal to 128 bits in data header |
| | | | flit) |
| 1 | Medium | High-priority | Real-time or streaming data, |
| | | access group | such as video |
| 2 | Low | Low-priority | Memory/register read and write |
| | | access group | access, data block (generally |
| | | | larger than 4096 bytes) |

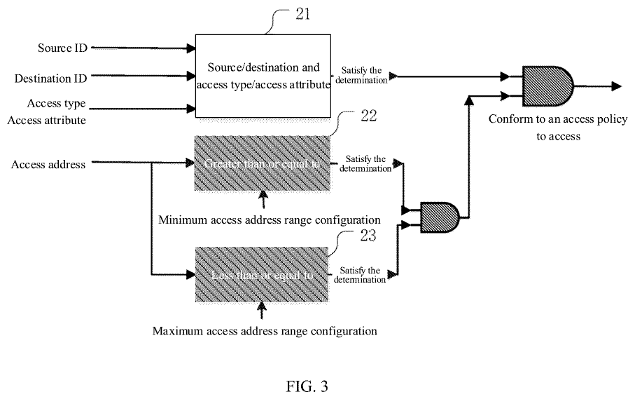

Further, referring to FIG. 3, FIG. 3 is a determination schematic diagram of an access policy firewall of a request allocation apparatus for a virtual channel according to an embodiment of the present application.

The access policy firewall mainly includes: a source/destination and access type/access attribute determination circuit 21 and an access address determination circuit (22 and 23 in FIG. 3).

The source/destination and access type/access attribute determination circuit 21 determines whether the access type and the access attribute between the source ID and the destination ID of the request support a trust zone access. The access supporting the trust zone may an access secure area and a non-secure memory area within the system, while a non-trust zone access may only access the non-secure memory area. The access address determination circuit detects whether a corresponding access address is within a configured accessible address range according to the source ID.

For example, an access feasibility vector of the destination ID0 and the source ID1 to source ID7 of the current request is [1, 1, 0, 1, 0, 1, 1, 0]. 1 represents accessible, and 0 represents inaccessible. The vector [1, 1, 0, 1, 0, 1, 1, 0] indicates that the source ID7, ID6, ID4, ID2, and ID1 may access the destination ID0, and the source ID5 and ID3 cannot access the destination ID0.

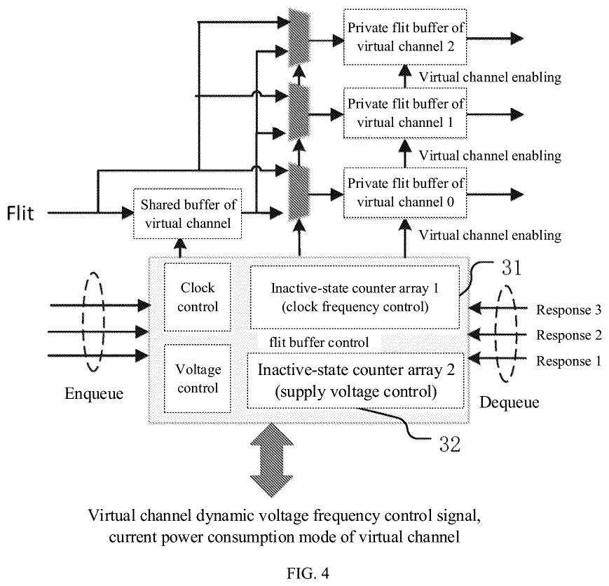

Referring to FIG. 4, FIG. 4 is a schematic diagram of a virtual channel access group of a request allocation apparatus for a virtual channel according to an embodiment of the present application.

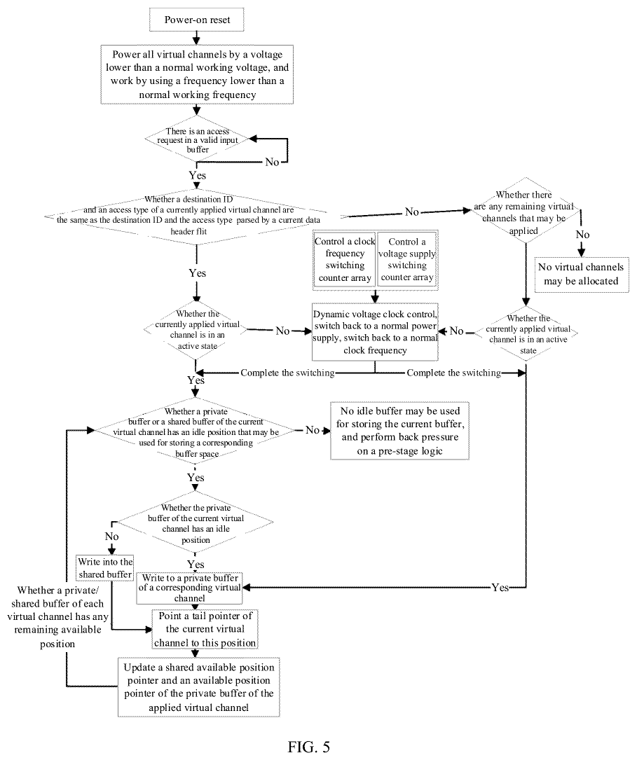

Referring to FIG. 5, FIG. 5 is a work flowchart of a virtual channel access group of a request allocation apparatus for a virtual channel according to an embodiment of the present application.

According to the foregoing description, the dynamic virtual channel access group in the present embodiment may improve virtual channel utilization rate. That is, in response to that the destination ID and the access type are the same, the same virtual channel is reused.

The virtual channels are organized in the form of queues, the same destination ID and access type belong to the same queue belonging to the same virtual channel, and different destination IDs or the same destination ID and different access types belong to different queues belonging to different virtual channels. The processing flow of dynamic virtual channel application and dynamic flit buffer management after receiving input channel flit (transmission microchip) is shown in FIG. 5. The virtual channel buffer includes 2 parts of a private buffer and a shared buffer.

Further, the dynamic virtual channel dynamic voltage frequency management refers to that all the virtual channels in an inactive state are powered by using a working voltage lower than a normal voltage and use a clock frequency lower than a normal working frequency (currently, the working frequency of the dynamic virtual channel in the inactive state may be selected as 1/16, ⅛, and ¼ of the normal working frequency). In response to that there is a valid request in the valid input buffer, a working state of a corresponding virtual channel is checked. If the virtual channel is in the inactive state, the normal voltage and working frequency are restored, and a data packet of the valid request enters the corresponding virtual channel. In response to that an idle counter of the virtual channel configured to control clock frequency switching reaches a threshold one (indicating that there is no data transmission during the period), a dynamic frequency control is requested (the counter is located at 31 in FIG. 4), and the clock frequency lower than the normal working frequency is used. In response to that the idle counter of the virtual channel configured to control the voltage reaches a threshold two (the threshold two is greater than the threshold one), the voltage lower than the normal working voltage is requested to power (the counter is located at 32 in FIG. 4). In response to that there is a request to be transmitted later, the normal voltage and working frequency are requested to be restored. If a valid request occurs in the process that the idle counter reaches the threshold one but does not reach the threshold two, it is only necessary to restore the normal working frequency.

It may be seen that in the present embodiment, in response to that there is the valid request in the valid input buffer, the working voltage and/or the working frequency of the dynamic virtual channel access group are regulated according to the current working state of the dynamic virtual channel access group, so that it is realized that the voltage and the frequency of the dynamic virtual channel access group are dynamically regulated, rather than using a fixed voltage and frequency to work, thereby the efficiency of processing the request is improved. Meanwhile, the request is inputted into the dynamic virtual channel access group of the corresponding priority according to the priority of the request to achieve differential processing on requests of different priorities, thereby the efficiency of request allocation is further improved.

A terminal device is further provided by the embodiments of the present application, which includes:
a memory, configured to store a computer program; and
a processor, configured to implement the steps of the request allocation method according to the embodiments stated above in response to executing the computer program.

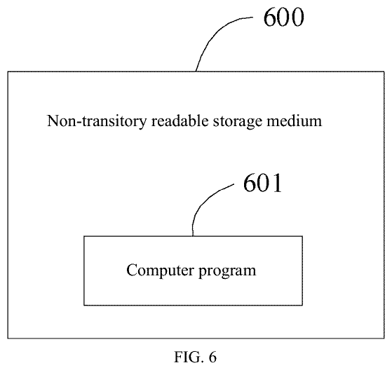

A non-transitory readable storage medium is further provided by the embodiments of the present application. As shown in FIG. 6, FIG. 6 is a schematic diagram of a frame of a non-transitory readable storage medium according to an embodiment of the present application. The non-transitory readable storage medium 600 storing a computer program 601, wherein in response to that the computer program is executed by a processor, the steps of the request allocation method according to the embodiments stated above are implemented.

Various embodiments are described in the specification in a progressive manner, with each embodiment focusing on its differences from the other embodiments. The same or similar parts between the various embodiments may be referred to each other. The apparatus disclosed in the embodiments corresponds to the method disclosed in the embodiments, so the description is relatively simple, and relevant parts may be referred to the description in the method section.

A person skilled in the art would further recognize that the units and algorithm steps of the examples described in connection with the embodiments disclosed herein may be implemented in electronic hardware, computer software, or combinations of the two. In order to clearly illustrate the interchangeability of hardware and software, the composition and steps of each example have been described in the above description in general terms according to functions. Whether these functions are implemented in hardware or software depends on the particular application and design constraints of the technical solution. A person skilled in the art may use different methods to achieve the described function for each particular application, but such realization should not be considered outside the scope of the present application.

The steps of methods or algorithms described in connection with the embodiments disclosed herein may be implemented directly in hardware, in a software module executed by a processor, or in a combination of the two. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The request allocation method for the virtual channel, the request allocation apparatus for the virtual channel, the terminal device, and the non-transitory readable storage medium provided by the present application are described in detail above. The principles and implementations of the present application have been described herein using examples, and the description of the above embodiments is intended only to help understand the method and its core idea of the present application. It should be noted that various improvements and modifications may be made to the present application by a person skilled in the art without departing from the principles of the present application, and these improvements and modifications also fall within the scope of the claims of the present application.

1. A request allocation method for a virtual channel, comprising:
inputting a request that is received into a valid input buffer;
in response to that there is a valid request in the valid input buffer, regulating a working voltage and/or a working frequency of a dynamic virtual channel access group according to a current working state of the dynamic virtual channel access group;
inputting the request into the dynamic virtual channel access group of a corresponding priority according to a priority of the request; and
outputting the request to a corresponding physical channel through the dynamic virtual channel access group.

2. The request allocation method according to claim 1, wherein inputting the request that is received into the valid input buffer comprises:
receiving the request, and inputting the request into an access policy firewall;
in response to that the request conforms to a policy of the access policy firewall, sending the request to the valid input buffer; and
in response to that the request does not conform to the policy of the access policy firewall, sending access error information to a requester.

3. The request allocation method according to claim 1, wherein inputting the request that is received into the valid input buffer comprises:
in response to that the request is received, reducing a current credit value by one to obtain a new current credit value, and inputting the request into the valid input buffer; and
in response to that the current credit value is zero, sending a message corresponding to suspending receiving the current credit value.

4. The request allocation method according to claim 1, wherein in response to that there is the valid request in the valid input buffer, regulating the working voltage and/or the working frequency of the dynamic virtual channel access group according to the current working state of the dynamic virtual channel access group comprises:
in response to that there is the valid request in the valid input buffer, determining whether the current working state of the dynamic virtual channel access group is an idle state; and
in response to that the current working state is the idle state, restoring the working voltage and/or the working frequency of the dynamic virtual channel access group to a normal state.

5. The request allocation method according to claim 4, wherein restoring the working voltage and/or the working frequency of the dynamic virtual channel access group to the normal state comprises:
in response to that the dynamic virtual channel access group is set to an active state, restoring the voltage of the dynamic virtual channel access group to a normal working voltage; and
in response to that the voltage is restored to the normal working voltage, restoring the working frequency of the dynamic virtual channel access group to a normal working frequency.

6. The request allocation method according to claim 1, wherein in response to that there is the valid request in the valid input buffer, regulating the working voltage and/or the working frequency of the dynamic virtual channel access group according to the current working state of the dynamic virtual channel access group comprises:
in response to that there is the valid request in the valid input buffer, determining whether the current working state of the dynamic virtual channel access group is a semi-idle state; and
in response to that the current working state is the semi-idle state, restoring the working frequency of the dynamic virtual channel access group to the normal state.

7. The request allocation method according to claim 6, wherein restoring the working frequency of the dynamic virtual channel access group to the normal state comprises:
in response to that the dynamic virtual channel access group is set to an active state, restoring the working frequency of the dynamic virtual channel access group to the normal state.

8. The request allocation method according to claim 1, wherein inputting the request into the dynamic virtual channel access group of the corresponding priority according to the priority of the request comprises:
in response to that the priority of the request is a high priority, inputting the request into the dynamic virtual channel access group of the high priority; and
in response to that the priority of the request is a low priority, inputting the request into the dynamic virtual channel access group of the low priority.

9. The request allocation method according to claim 1, wherein outputting the request to the corresponding physical channel through the dynamic virtual channel access group comprises:
outputting the request from the dynamic virtual channel access group to the corresponding physical channel through dynamic priority arbitration.

10. The request allocation method according to claim 1, wherein the request allocation method further comprises:
in response to that the dynamic virtual channel access group is in an inactive state, controlling the dynamic virtual channel access group to work at a first working voltage and a first working frequency, wherein the first working voltage is less than a normal working voltage, and the first working frequency is less than a normal working frequency.

11. The request allocation method according to claim 10, wherein in response to that the dynamic virtual channel access group is in the inactive state, controlling the dynamic virtual channel access group to work at the first working voltage and the first working frequency comprises:
in response to that the dynamic virtual channel access group is in the inactive state, controlling the dynamic virtual channel access group to work at the first working frequency; and
in response to that a duration of working at the first working frequency is longer than a preset duration, controlling the dynamic virtual channel access group to work at the first working voltage.

12. The request allocation method according to claim 1, wherein outputting the request to the corresponding physical channel through the dynamic virtual channel access group comprises:
outputting the request from the dynamic virtual channel access group to the corresponding physical channel through dynamic priority arbitration of 8 transmission channels.

13. The request allocation method according to claim 2, wherein receiving the request, and inputting the request into the access policy firewall comprises:
receiving the request, and inputting an access type, an access attribute, and an access address of the request into the access policy firewall.

14. The request allocation method according to claim 13, wherein the access policy firewall comprises: a source/destination and access type/access attribute determination circuit and an access address determination circuit; the source/destination and access type/access attribute determination circuit is configured to determine whether an access type and an access attribute of the request support a trust zone access, and the access address determination circuit is configured to detect whether a corresponding access address is within a configured accessible address range according to a source identifier (ID) of the request.

15. The request allocation method according to claim 14, wherein the request allocation method further comprises:
in response to that the access type and the access attribute of the request support the trust zone access, and according to the source ID of the request, it is detected that the corresponding access address is within the configured accessible address range, determining that the request conforms to the policy of the access policy firewall.

16. The request allocation method according to claim 14, wherein the request allocation method further comprises:
in response to that any one or more of the following are satisfied, determining that the request conforms to the policy of the access policy firewall:
the access type and/or the access attribute of the request not supporting the trust zone access, and according to the source ID of the request, detecting that the corresponding access address is not within the configured accessible address range.

17. The request allocation method according to claim 1, wherein inputting the request into the dynamic virtual channel access group of the corresponding priority according to the priority of the request comprises:
inputting the request into the dynamic virtual channel access group of the corresponding priority according to the priority, a destination identifier (ID), and an access type of the request.

18. The request allocation method according to claim 1, wherein the valid request is a request that conforms to a policy of an access policy firewall.

19. A terminal device, comprising:
a memory, configured to store a computer program; and
a processor, configured to implement the steps of the request allocation method according to claim 1 in response to executing the computer program.

20. A non-transitory readable storage medium storing a computer program, wherein in response to that the computer program is executed by a processor, the steps of the request allocation method according to claim 1 are implemented.
